(19) United States
(12) Patent Application Publication
(10) Pub. No.: US 2009/0224675 A1
(43) Pub. Date: Sep. 10, 2009

(54) LIGHTING UNIT

(76) Inventors: Pavel Pekarski, Aachen (DE); Gero Heusler, Aachen (DE); Holger Moench, Vaals (NL); Jens Pollmann-Retsch, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 11/568,032

(22) PCT Filed: Apr. 6, 2005
(86) PCT No.: PCT/IB2005/051124

§ 371 Date: Oct. 18, 2006

(30) Foreign Application Priority Data
Apr. 21, 2004 (EP) 0410644.5

(51) Int. Cl. H01J 61/20; H01J 61/00

(52) U.S. Cl. 313/639; 313/567

(57) ABSTRACT

The invention relates to a lighting unit comprising at least a high-pressure gas discharge lamp, which comprises at least a lamp bulb (1) with a discharge space (21) in which two electrodes (41, 42) are arranged and in which a gas mixture with ingredients capable of condensation is present, wherein a risk of condensation deposit between and/or on the two electrodes (41, 42) exists, and which comprises an ignition device and a unit for local heating (5) of the lamp bulb (1), characterized in that the lighting unit comprises at least one unit for local cooling (6) of the lamp bulb (1).

The invention relates to a lighting unit comprising at least a high-pressure gas discharge lamp, which comprises at least a lamp bulb with a discharge space in which two electrodes are arranged and in which a gas mixture with ingredients capable of condensation is present, wherein a risk of short-circuit caused by a condensation deposit between the two electrodes exists, and which comprises an ignition device and a unit for locally heating the lamp bulb.

High-pressure gas discharge lamps (HID or High Intensity Discharge lamps) and in particular UHP (Ultra High Performance) lamps are used by preference inter alia for projection purposes because of their optical properties.

A light source which is as point-shaped as possible is required for such applications, such that the luminous arc forming between the electrode tips should not exceed a length of approximately 2.5 mm. Furthermore, as high as possible a luminous intensity is often required in combination with as natural a spectral composition of the light as possible.

In recent years, furthermore, high-pressure gas discharge lamps with shorter electrode spacings have come into demand. For example, such UHP lamps with electrode spacings of less than 1 mm are commercially available, and those of approximately 0.7 mm are under development at present.

One of the ingredients capable of condensation in the gas mixture of such high-pressure gas discharge lamps is, for example, mercury. After condensation, the condensed mercury is often present in the form of droplets. Given the conditions in a usual UHP lamp, droplets of mercury of an order of magnitude above approximately 1.1 mm can often be observed.

Such droplets deposit themselves in particular in the coldest regions in the discharge space. Among these regions are also the two electrodes, because the latter transport heat to the exterior comparatively quickly owing to heat conduction, after switching-off of the UHP lamp.

Given electrode spacings of less than 1 mm, in particular less than 0.7 mm, there is a risk that a droplet, for example of condensed mercury, deposits itself between the two electrodes. This may lead to a short-circuit upon a renewed attempt to ignite the lamp. A successful ignition of the lamp is then excluded or at least rendered more difficult, which is undesirable in any case.

Alternatively or in addition, these droplets may also deposit themselves on the two electrodes. This does not often lead to a short-circuit, but it is still undesirable because it adversely affects the ignition among other things. Condensation deposits on only one electrode, by contrast, are usually not detrimental.

Possibilities for solving this problem are known in principle from US 2003/0011320. It is suggested as a solution to this problem, for example, to achieve an evaporation of the condensed mercury droplets by means of local heating, thus eliminating the risk of short-circuits. The proposed solution, however, does not render possible a quick ignition of the lamp, in particular at an internal mercury pressure that is already high, or a higher ignition voltage is required. There is a tendency nowadays to design ignition devices having a comparatively low ignition voltage, i.e. ignition voltages below 3 kV. This means that the ignition of the high-pressure gas discharge lamp is not reliably ensured at each and every desired moment.

It is an object of the invention to provide a lighting unit of the kind mentioned above which can be reliably and quickly ignited in those cases in which a condensate has deposited itself between the electrodes, leading to a short-circuit of the high-pressure gas discharge lamp, or in which a condensate has deposited itself on both electrodes.

The object of the invention is achieved in that the lighting unit comprises at least a unit for locally cooling the lamp bulb.

This defined local cooling according to the invention has the result that any condensate that is deposited will deposit such that the ignition is reliably made possible.

The unit for locally cooling the lamp bulb according to the invention serves to cool at least a region of the lamp bulb such that the two electrodes do not form the coldest spot in the discharge space.

According to the invention, a local cooling is realized such that, should a condensate deposit itself between the electrodes and the two electrodes should be interconnected with electrical conduction by this condensate, a local heating takes place such that the condensate again enters the gas phase and no longer interconnects the two electrodes with electrical conduction, while nevertheless the local cooling ensures that the internal pressure in the discharge space does not rise, or at least does not rise to such an extent that a reliable ignition is no longer possible.

The dependent claims relate to advantageous further embodiments of the invention.

A particularly advantageous embodiment of the invention relates to a lighting unit with an UHP lamp which comprises a gas mixture with mercury among its ingredients. This unit serves in particular for projection purposes.

Preferably, a short-circuit caused by condensation deposits is detected by means of a unit for ascertaining a short-circuit between the electrodes. This unit is in particular a device for measuring the electrical resistance between the two electrodes. This renders it possible to realize the required local heating and cooling immediately upon a first. detection of a relevant short-circuit, should this be desired in the context of lamp operation. After the desired state has been reached, i.e. the deposited condensation between the electrodes has been removed and the desired internal pressure has been adjusted in dependence on the ignition voltage specific to the construction, an immediate and reliable ignition is provided.

When a short-circuit is detected, local cooling takes place simultaneously with or consecutive to the local heating process, such that a renewed condensation deposit between the electrodes is prevented. This achieves in particular that the lamp can be quickly and reliably ignited.

It is furthermore preferred that the unit for locally heating the lamp bulb heats the partial region of the discharge space in which the one electrode is present more strongly than the partial region of the discharge space in which the other electrode is present.

It is furthermore preferred that the unit for locally heating the lamp bulb can be switched on and off, for example by means of a usual switching unit, i.e. it is not permanently heating. This is useful, for example, in the case in which a unit for detecting a short-circuit between the electrodes is used.

A permanent local heating and cooling in the sense of the invention in the time period before the next ignition operation is alternatively possible in certain cases. In these special cases a detection of a relevant short-circuit may be dispensed with, for example for constant conditions of use of the lighting unit, i.e. constant mounting position and operating conditions.

It is particularly preferred for the nature of the unit for locally heating the lamp bulb that said unit comprises at least a heating coil, radiation heating, or induction heating unit. It is particularly preferred that the heating coil can in addition be switched as an ignition aid.

It is particularly advantageous that the unit for locally cooling the lamp bulb cools the partial region of the discharge space in which the one electrode is present more strongly than the partial region of the discharge space in which the other electrode is present. It is preferred for the type of unit for locally cooling the lamp bulb that said unit comprises at least an air cooling.

It is preferred for the operation of a lighting unit according to the invention that a unit for locally heating a partial region of the lamp bulb and at the same time or subsequently a unit for cooling a partial region of the lamp bulb can be switched on upon a detection of a short-circuit between the electrodes but before the start of the ignition unit.

It is alternatively or additionally preferred for the operation of a lighting unit according to the invention that the unit for heating a partial region of the lamp bulb and the unit for cooling at least a partial region of the lamp bulb can be switched on after the detection that no short-circuit is present anymore between the electrodes, but before the start of the ignition unit. This special embodiment is preferred in the case in which condensation deposits are present on both electrodes. Alternatively, the embodiment mentioned above is also of practical use in principle in the case in which the detection of the presence of a possible short-circuit does not take place.

It is furthermore preferred that a unit for heating at least one electrode is arranged in an electrical circuit such that the occurrence of a condensation deposit between the electrodes automatically closes the electrical circuit. It is achieved thereby that heating takes place only in those cases in which the risk of a short-circuit arises during ignition of the lamp.

A condensation deposit can thus be eliminated in a lighting unit according to the invention, for example in the so-termed standby mode, i.e. when the lighting unit is ready for operation but the light source has not yet been activated. Activation of the light source can then take place more quickly.

Further particulars, features, and advantages of the invention will become apparent from the ensuing description of a preferred embodiment, which is given with reference to the drawing in which:

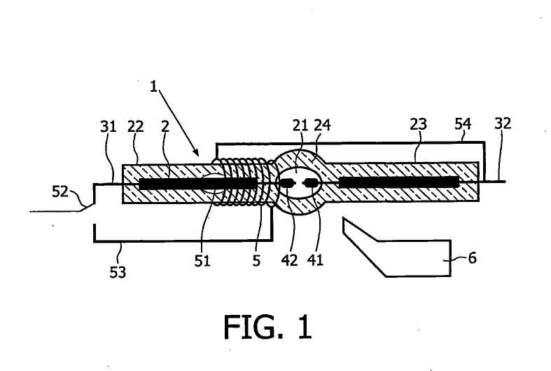

FIG. 1 diagrammatically shows a lamp bulb of a high-pressure gas discharge lamp (UHP lamp) in cross-section.

FIG. 1 is a diagrammatic cross-sectional view of a lamp bulb 1 of a high-pressure gas discharge lamp (UHP lamp) of the lighting unit according to the invention in a horizontal mounting position. The burner 2, which is made of one piece, which hermetically encloses a discharge space 21 filled with a gas mixture usual for the purpose and comprising ingredients capable of condensation, and whose material is usually hard glass or quartz glass, comprises two cylindrical, mutually opposed regions 22, 23, between which a substantially spherical region 24 with a diameter in the range of approximately 9 mm is arranged. The outer contour of the burner wall has an elliptical shape in the region of the discharge chamber 21. The discharge space 21 with its electrode arrangement is centrally arranged in the region 24. The electrode arrangement substantially comprises a first electrode 41 and a second electrode 42, the tips of said electrodes 41, 42 being spaced apart by approximately 0.7 mm.

An ignition device (not shown in FIG. 1) excites a luminous arc discharge in the discharge chamber 21 between the mutually opposed tips of the electrodes 41, 42 in a usual manner, such that the luminous arc serves as a light source of the high-pressure gas. discharge lamp or lighting unit according to the invention. The ignition voltage, which is generated by a usual ignition device, is approximately 3 kV. The ends of the electrodes 41, 42, which are arranged on the major axis of symmetry of the discharge chamber 21, are connected to electrical connections 31, 32 of the lamp, via which a supply unit (not shown in FIG. 1) designed for connection to a public mains voltage delivers the supply voltage necessary for operating the lamp.

A usual heating coil 51 is arranged in the region 22, forming part of a unit for locally heating 5 the lamp bulb 1. The unit for locally heating 5 further comprises at least a supply unit designed for connection to a mains voltage, an electrical switching device 52, and suitable electrical connection lines 53, 54.

The unit for local cooling 6, shown diagrammatically only in FIG. 1, comprises besides a cooling air blower also at least a supply unit designed for connection to a public mains voltage, which delivers in particular the supply voltage necessary for operating the cooling fan, an electric switching device, and suitable electrical connection lines. Cooling takes place in a usual manner with the use of nozzles which serve for a directional blowing against the burner 2 forming part of the lamp bulb 1, or of the spherical region 24 thereof. The cooling envisaged here is usually most effective when the cooling air hits the region where the coldest spots of the region 24 are present. These coldest region are in the lowermost portion of the spherical region 24 in the case of horizontal mounting.

The lighting unit according to the invention in addition comprises a unit for detecting a short-circuit between the electrodes (not shown in FIG. 1) of the high-pressure gas discharge lamp, which in particular is a conventional unit for measuring the electrical resistance between the two electrodes 41, 42.

Individual operational conditions of the lighting unit according to the invention will be described one after the other for further clarification of the invention. If the lighting unit is to be used, for example, for projection purposes, such that at a given moment the corresponding quantity of light must be available, it should be safeguarded that no condensation has deposited itself between the tips of the electrodes 41, 42 so as to ensure a reliable ignition. To detect this, a known resistance measurement takes place for the tips of the electrodes 41, 42. If the conditions denoting the presence of condensation are detected, the unit for local heating 5 of the electrode 42 is switched on. The heating coil 51 heats the partial region of the discharge space in which the electrode 42 is present more strongly than the partial region of the discharge space in which the electrode 41 is present. The condensation is converted to the gas phase again by this heating, and the gas pressure in the discharge space 21 rises. Therefore, after a short-circuit between the electrodes 41, 42 has been detected, but before the start of the ignition unit, the unit for locally heating 5 a partial region of the lamp bulb 1 is switched on, as is at the same time or subsequently the unit 6 for cooling a different partial region of the lamp bulb 1. The spatially defined cooling reduces the gas pressure in the discharge space 21 again, so that the reliable ignition of the gas mixture by means of a comparatively low ignition voltage can be realized.

1. A lighting unit comprising at least a high-pressure gas discharge lamp, which comprises at least a lamp bulb (1) with a discharge space (21) in which two electrodes (41, 42) are arranged and in which a gas mixture with ingredients capable of condensation is present, wherein a risk of condensation deposit between and/or on the two electrodes (41, 42) exists, and which comprises an ignition device and a unit for local heating (5) of the lamp bulb (1), characterized in that the lighting unit comprises at least a unit for local cooling (6) of the lamp bulb (1).

2. A lighting unit as claimed in claim 1, characterized in that the high-pressure gas discharge lamp is a UHP lamp which contains a gas mixture with mercury as one of its ingredients.

3. A lighting unit as claimed in claim 1, characterized in that the lighting unit comprises a unit for detecting a short-circuit between the electrodes (41, 42) of the high-pressure gas discharge lamp, which unit comprises in particular a device for measuring the electrical resistance between the two electrodes (41, 42).

4. A lighting unit as claimed in claim 1, characterized in that the unit for local heating (5) of the lamp bulb (1) heats the partial region of the discharge space (21) in which the one electrode is present more strongly than the partial region of the discharge space (21) in which the other electrode is present.

5. A lighting unit as claimed in claim 4, characterized in that the unit for local heating (5) of the lamp bulb (1) can be switched on and off.

6. A lighting unit as claimed in claim 4, characterized in that the unit for local heating (5) of the lamp bulb (1) comprises at least a heating coil (51), radiation heating, or induction heating unit.

7. A lighting unit as claimed in claim 6, characterized in that the heating coil (51) can be switched in addition as an ignition aid.

8. A lighting unit as claimed in claim 1, characterized in that the unit for local cooling (6) of the lamp bulb (1) cools the partial region of the discharge space (21) in which the one electrode is present more strongly than the partial region of the discharge space (21) in which the other electrode is present.

9. A lighting unit as claimed in claim 8, characterized in that the unit for local cooling (6) of the lamp bulb (1) comprises at least an air cooling.

10. A lighting unit as claimed in claim 1, characterized in that a unit for local heating (5) of another partial region of the lamp bulb (1) and at the same time or subsequently a unit for cooling (6) of a partial region of the lamp bulb (1) can be switched on upon detection of a short-circuit between the electrodes (41, 42) but before the start of the ignition unit.

11. A lighting unit as claimed in claim 1, characterized in that the unit for heating (5) of a partial region of the lamp bulb (1) and the unit for cooling (6) of at least a partial region of the lamp bulb (1) can be switched on after the detection that no short-circuit is present anymore between the electrodes (41, 42), but before the start of the ignition unit.

12. A lighting unit as claimed in claim 1, characterized in that a unit for heating (5) of at least one electrode, in particular a heating coil (51), is arranged in a circuit arrangement such that the electrical circuit thereof is automatically closed by the occurrence of a condensation deposit between the electrodes (41, 42).

13. A projection system with at least one lighting unit as claimed in claim 1.
